(19) United States
(12) Patent Application Publication
(10) Pub. No.: US 2015/0011251 A1
(43) Pub. Date: Jan. 8, 2015

(54) Method For Transmitting Voice Audio Captions Transcribed Into Text Over SMS Texting

(71) Applicant: Raketu Communications, Inc., New York, NY (US)

(72) Inventor: Gregory T. Parker, New York, NY (US)

(21) Appl. No.: 14/316,237

(22) Filed: Jun. 26, 2014

Related U.S. Application Data
(60) Provisional application No. 61/843,695, filed on Jul. 8, 2013.

(51) Int. Cl. H04W 4/14; G10L 15/26

(52) U.S. Cl. CPC H04W 4/14; G10L 15/26
USPC 455/466

(57) ABSTRACT

A method for transmitting text captions to a mobile device. The text captions are derived from audio and video calls or broadcasts, and may be for deaf or hearing impaired users, or others requiring voice-to-text captions on mobile devices. The invention provides for the audio or video voice information to be transcribed into text and delivered via SMS-texting (Short Message Service) without the need for an IP connection. The receiving caller may see and read the text transcriptions and/or translations of the audio without having an IP connection. Since an IP connection is not always available or reliable on mobile devices, the ability to deliver the text captions via SMS-texting allows the users to operate at virtually anytime, anywhere, and without the necessity of adding a costly data plan to their mobile service.

Priority is claimed from U.S. provisional patent application Ser. No. 61/843,695, filed Jul. 8, 2013.

### FIELD OF INVENTION

The present invention relates generally to text, audio and video communications, messages and signals, and more particularly to methods for transmitting text captions of audio and video over short message service (SMS) texts to mobile devices.

### BACKGROUND

Mobile devices connecting to an Internet Protocol (IP) network typically carry out many forms of communications activities, primarily audio and video communications. Few services transcribe audio into text captions, derived from the audio portion of a voice or video call or broadcast. For audio to text service delivery, a common implementation is to deploy a continuously connected application via an IP connection to a communications server. This allows the server to continuously transmit the text captions to the mobile device. This type of deployment leads to the requirement that the mobile device have simultaneous voice and data capabilities and the user have both voice and data service plans. In addition this type of persistent deployment of transmitting text captions via IP leads to constant resource utilization on the mobile device, specifically negatively impacting battery, CPU, and network resources.

One common implementation for transmitting to a mobile device text captions from audio calls is to allow the audio to be delivered via the voice channel (standard mobile phone voice) and the text captions to be delivered via a persistent IP data connection to a communications server that is relaying the audio to text transcriptions to the device, FIG. 1 is a block diagram illustrating such prior art systems. The system includes an IP caption gateway server (200), a Public Switched Telecommunications Network (PSTN) interconnect server (210), a mobile call receiver (100), and an audio/video phone (300). The mobile call receiver (100) is persistently connected to the IP caption gateway server (200) for receiving text captions, and the PSTN interconnect server (210) for sending/receiving voice. If the mobile call receiver (100) was to become disconnected from the IP caption gateway server (200), disrupting the data connection, the mobile call receiver would not be able to receive any text captions. The mobile call receiver (100) continuously seeks to be connected to the IP caption gateway server (200) and the PSTN interconnect server (210), and must be connected to both the IP data connection and voice connection—simultaneous voice and data must be supported and available at all times. If the mobile call receiver (100) temporarily becomes disconnected from the IP caption gateway server (200), it typically goes into a state of automated retries as it attempts to reconnect. If no reconnection can be established, the call is dropped and the text captions will no longer be delivered. If the mobile call receiver (100) does not support simultaneous voice and data, or the user does not have both voice and data services active on their plan, they cannot use this type of implementation. In addition, using this type of implementation results in a constant usage of the mobile devices resources, specifically the CPU, battery and network resources.

In order to receive a text captioned audio or video call on the mobile receiver (100), the audio/video phone (300) would initiate a call via the PSTN (210) (in the case of audio) establishing an outbound audio stream (1) and an inbound audio stream (4) to the PSTN. The outbound audio stream (1) would be relayed via the PSTN (210) to the mobile receiver (100) over the inbound audio stream (2), and the mobile receiver (100) outbound audio stream (3) would be established with the PSTN (210) which would relay the stream to the audio/video phone (300) over the inbound audio stream (4). With text captions, the PSTN also relays the audio/video phone (300) outbound audio stream (1) to a Voice-To-Text translator (230) via (5), which converts the audio to text, which text is then relayed (6) to an IP caption gateway server (200). The IP caption gateway server (200) then relays the text captions to the mobile receiver (100) over a persistent IP connection (7), where the mobile receiver (100) receives and displays the text captions.

If a prior art mobile receiver's normal IP data connection to the network is interrupted, any text captions would cease and the call would be dropped.

Although the conventional systems such as depicted in FIG. 1 perform adequately, there are very high costs on mobile resources associated with such systems. Namely, the mobile device and service provider must support simultaneous voice and data services, the user must have both a voice and data plan, and the mobile device must be able to connect via the data plan for the duration of the voice/video call.

One problem is that the battery life of mobile devices is significantly impacted by using simultaneous voice and IP data services, and can result in the reduction of over 75% of a mobile device battery power availability using the conventional system.

Another problem is that using the conventional system, the mobile device's CPU is constantly and persistently being utilized during the text captioned call, which results in increased power consumption and reduced processing capacity availability to process other activities, tasks and applications on the mobile device.

Current efforts to address the power consumption problem are directed toward improvements in power supplies and battery life, as well as improved and more efficient processors. Such efforts may require replacement of existing devices, rather than providing an improvement in the operation of existing devices. Device users are also encouraged to deactivate features of their device to improve battery life, making the devices less useful.

Another problem is that using the conventional system, the mobile device's network connectivity is persistently engaged and being accessed during a call. This results in dramatically increased bandwidth utilization by the mobile device, which adversely affects the mobile device's ability to service other applications that require network access, and has the potential to dramatically increase the cost of operation to the mobile device owner (example: increased mobile data roaming charges based on usage). The persistent connection to the network also presents a greater load on the network resources.

Another problem is that the mobile receiver must be capable of supporting simultaneous voice and IP data services, must have both activated and subscribed to, and both services must be available for the duration of the text captioned call. These requirements result in increased costs to the user who must have an active IP data plan in addition to their voice plan. The user must also be in a location where their IP data connection will remain connected. Using the IP data connection puts additional network usage on the network operator/supplier's infrastructure, which can result in higher operational costs for both the operator/supplier and the user.

A solution to these problems would provide a mobile receiver with the ability to receive text captions over SMS-text. The mobile device would not need to support simultaneous voice and IP data services, nor would the user have to have a voice and IP data plan. The mobile device would not maintain a persistent connection to the network. By not being constantly connected to the IP data network and by delivering the text captions over SMS-text services, the invention system and method significantly reduces the resource requirements, costs and reliability over conventional methods on a mobile device.

### SUMMARY OF THE INVENTION

The following is a summary of the invention in order to provide a basic understanding of some aspects of the invention. This summary is intended to present some concepts of the invention in a simplified form as a prelude to the more detailed description that is presented later.

In the invention, the text captions are delivered via standard SMS-texts which only require the mobile device to support voice/text and the user to only require a voice service plan. In addition, the resource reduction of battery, CPU, and network are achieved over conventional methods for receiving text captions on mobile devices.

The present invention provides the ability to deliver the text-captions associated with a voice or video call or broadcast, over SMS-text to a mobile device. The user on the mobile device can listen to audio, and/or watch video, while reading a transcription of the audio as text. No IP data services are required, and the text captions are delivered periodically, allowing for the captions to be pushed to the mobile receiver and not requiring a continuous connection.

The present invention, as depicted in FIG. 2 and FIG. 3, relates generally to systems and methods for audio and video communications, messages and signals, and more particularly to systems and methods for the delivery of text-captions derived from audio and video calls to/from mobile devices. The invention can readily be implemented on mobile devices.

The present invention provides a messaging and signaling system that provides text-captions of audio or video over SMS (Short Message Service), removing the need that the mobile device and service provider support simultaneous voice and data. The invention reduces the mobile device resource requirements, and is highly scalable and highly flexible in its implementation. The invention eliminates the need for a user to have data service in order to delivered text-captioned audio.

The present invention reduces power consumption of the mobile device, due to the mobile device not having to maintain a constant and persistent IP data connection to the server. The reduction in power consumption increases the battery life, the amount of time that a mobile device can operate before recharging.

The present invention reduces central processing unit (CPU) cycle consumption of the mobile device, due to the mobile device not having a constant and persistent connection to the server. The reduction in CPU cycle consumption increases the device's available capacity to process other activities, tasks and applications, increases battery life, and results in a faster, richer user experience.

The present invention reduces network consumption, as the mobile device will not need to maintain a constant and persistent connection to the server over an IP network. This results in no IP data bandwidth utilization by the mobile device, which increases the mobile devices' ability to service other applications that require network access, increases battery life, and has the potential to dramatically decrease the cost of operation to the mobile device owner (example: decreased mobile data roaming charges based on usage over conventional systems). In addition, the network provider will have additional resources available that would otherwise be engaged with a constant and persistent connection to a mobile device.

The present invention eliminates the requirement of the mobile device and the service provider having the ability to support simultaneous voice and data services.

The present invention eliminates the requirement of the user having a data services plan, thus reducing ongoing costs significantly.

To the accomplishment of the foregoing and related ends, certain illustrative aspects of the invention are described herein in connection with the description and the annexed drawings. These aspects are indicative of various ways in which the invention may be practiced, all of which are intended to be covered by the present invention. Other advantages and novel features of the invention may become apparent from the following detailed description of the invention when considered in conjunction with the drawings.

### BRIEF DESCRIPTION OF THE DRAWINGS

FIG. 1 is block diagram illustrating a Conventional Caption Voice Call Network Flow.

FIG. 2 is a block diagram illustrating a SMS Delivered Caption Voice Call Network Flow—an aspect of the present invention.

FIG. 3 is a block diagram illustrating a SMS Delivered Caption Data Network Flow—an aspect of the present invention.

### DETAILED DESCRIPTION OF THE PREFERRED EMBODIMENT

The present invention is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

As used in this application, the terms “component” and “system” and “server” are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

It is to be appreciated that, for purposes of the present invention, any or all of the functionality associated with modules, systems and/or components discussed herein can be achieved in any of a variety of ways (e.g. combination or individual implementations of active server pages (ASPs), common gateway interfaces (CGIs), application programming interfaces (API's), structured query language (SQL), component object model (COM), distributed COM (DCOM), system object model (SOM), distributed SOM (DSOM), ActiveX, common object request broker architecture (CORBA), remote method invocation (RMI), C, C++, Java, practical extraction and reporting language (PERL), applets, HTML, dynamic HTML, server side includes (SSIs), extensible markup language (XML), portable document format (PDF), wireless markup language (WML), standard generalized markup language (SGML), handheld device markup language (HDML), other script or executable components).

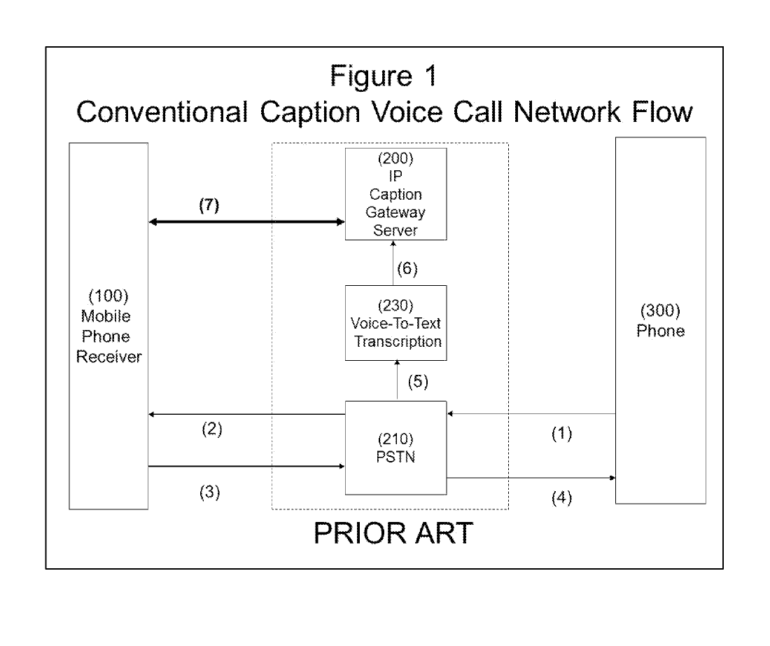

FIG. 1 is a block diagram of prior art systems, showing a mobile phone receiver (100) connecting to a PSTN server (210) and an IP caption gateway server (200). In FIG. 1, the persistent IP data connection of the prior art is depicted by a solid arrow line (7). The mobile phone receiver (100) is depicted engaged in telephone communication with phone (300), transmitting (3) and (4) through PSTN server (210) to phone (300) and receiving (1) and (2).

The present invention presents an approach to system efficiency that is contrary to current industry practice. The communications industry traditionally pursues a model where each mobile device is persistently connected to a network via an IP data connection in order to deliver captions. In contrast, the present invention presents an SMS-texting model for delivery or captions, alleviating the requirement of an IP data connection entirely.

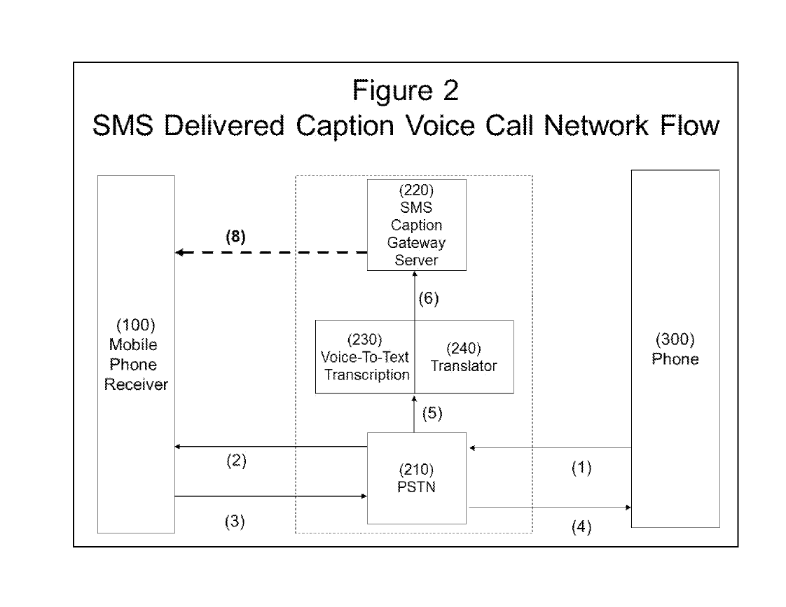

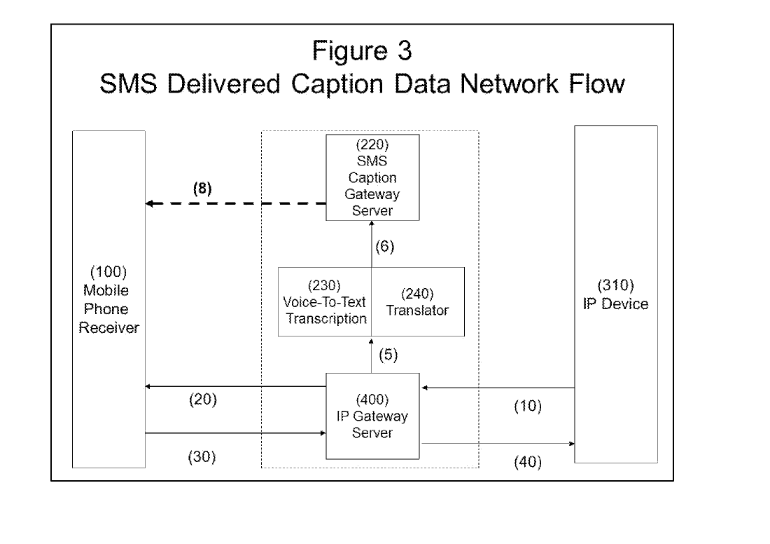

FIG. 2 is a block diagram illustrating an SMS delivered caption voice call network flow according to an aspect of the present invention. FIG. 3 is a block diagram illustrating an SMS delivered caption data network flow according to another aspect of the present invention. In FIG. 2 and FIG. 3, the caption gateway delivery of SMS-texts to the mobile receiver of the present invention is depicted by a dashed arrow line (8).

In FIG. 2, the mobile device (100) either initiates or receives an audio or video text-captioned call request. The user connects to the appropriate services for the audio or video stream (example PSTN), and is connected to the call. When the caption gateway server receives the audio-to-text translations, it relays the text in SMS-text format to the mobile device, where the user may read the text captions of the audio/video call while the call is in progress.

The system includes a SMS caption relay server (220), a PSTN server (210), and a mobile receiver (100). During an audio/video call, audio/video phone (300) is connected with mobile receiver (100) through PSTN server (210). The mobile receiver (100) is not persistently nor intermittently connected to the SMS caption relay server (220). The mobile receiver (100) need not be connected via IP data services to the SMS caption relay server (220), or an IP caption relay server, such as in the prior art, at any time.

A call between mobile phone receiver (100) and audio/video phone (300) is initiated and placed through the PSTN server (210). An outbound audio stream (1) and an inbound audio stream (4) are established between the PSTN and audio/video phone (300). The outbound audio stream (1) would be relayed via the PSTN (210) to the mobile receiver (100) over the inbound audio stream (2), and the mobile receiver (100) outbound audio stream (3) would be established with the PSTN (210) which would relay the stream to the audio/video phone (300) over the inbound audio stream (4). The PSTN server (210) also relays the audio/video phone (300) outbound audio stream (1) to a Voice-To-Text transcriber (230) via (5), which converts the audio to text, which is relayed (6) to an SMS caption gateway server (220).

The SMS caption relay server (220) then relays the text captions to the mobile receiver (100) over SMS-text using the regular mobile connection (8), where the mobile receiver (100) receives and displays the text captions. The SMS caption gateway server's (220) periodic polling time is dynamic and can be set to various intervals. If the amount of text retrieved during one of the polling cycles is too large to be sent as a single SMS-text message (current limitation is 160 7-bit characters, 140 8-bit characters, or 70 16-bit characters), the SMS caption gateway server (220) splits the message into the appropriate amount of separate messages required and sends them via SMS-text message stream (8) in sequence to the mobile receiver (100). If no new translation text is retrieved during one of the polling cycles, no SMS-text message is sent. Once the call is terminated, the SMS caption gateway server (220) ceases to poll the transcript and ceases to send SMS messages.

The transcription of the audio speech from the audio stream to text can be accomplished by any of a number of methods as is well known in the art. The invention is intended to be independent of the particular transcription method or subsystem.

In FIG. 3, the IP connected device (310) initiates or receives an audio or video text-captioned call request, or initiates an audio or video broadcast. The user (100) connects to the appropriate services for the audio or video stream (example IP Gateway), and is connected to the call or broadcast. When the caption gateway server receives the audio-to-text translations, it relays the text in SMS-text format to the mobile device, allowing the user to read text captions of the audio/video call or broadcast while it is in progress.

The system includes a SMS caption relay server (220), an IP Gateway server (400), and a mobile receiver (100). During an audio/video call or broadcast, IP device (310) is connected with mobile receiver (100) through IP Gateway server (400). The mobile receiver (100) is not persistently nor intermittently connected to the SMS caption relay server (220). The mobile receiver (100) need not be connected via IP data services to the SMS caption relay server (220), or an IP caption relay server, such as in the prior art, at any time. This leaves the IP data bandwidth available for the audio/video call or broadcast.

A video call between mobile phone receiver (100) and IP device (310) is initiated and placed through the IP Gateway server (400). An outbound audio/video stream (10) and an inbound audio/video stream (40) are established between the IP gateway server (400) and IP device (310). The outbound audio/video stream (10) would be relayed via the IP gateway server (400) to the mobile receiver (100) over the inbound audio/video stream (20). In the case of an audio/video call, the mobile receiver (100) outbound audio/video stream (30) would be established with the IP gateway server (400) which would relay the stream to the IP device (310) over the inbound audio/video stream (40). In the case of an audio/video broadcast from the IP device (310), the mobile receiver would not establish an outbound audio/video stream (30), and no inbound audio/video stream (40) to the IP device (310) would be established. The IP gateway server (400) also relays the IP device (310) outbound audio stream (10) to a Voice-To-Text transcriber (230) via (5), which converts the audio to text, which is relayed (6) to an SMS caption gateway server (220).

The SMS caption relay server (220) then relays the text captions to the mobile receiver (100) over SMS-text using the regular mobile connection (8), where the mobile receiver (100) receives and displays the text captions. The SMS caption gateway server's (220) periodic polling time is dynamic and can be set to various intervals. If the amount of text retrieved during one of the polling cycles is too large to be sent as a single SMS-text message (current limitation is 160 7-bit characters, 140 8-bit characters, or 70 16-bit characters), the SMS caption gateway server (220) splits the message into the appropriate amount of separate messages required and sends them via SMS-text message stream (8) in sequence to the mobile receiver (100). If no new translation text is retrieved during one of the polling cycles, no SMS-text message is sent. Once the call is terminated, the SMS caption gateway server (220) ceases to poll the transcript and ceases to send SMS messages.

In accordance with the present invention, captioned text can be retained at the SMS caption gateway server (220) during periods when the captioned text is too large to send as a single message, whereby the SMS caption gateway server (220) will divide the captioned text into snippets, and send the snippets in sequence as soon as is possible. In addition, the SMS caption relay server (220) can retain the captioned text, or portions thereof, if the mobile call receiver (100) is not receiving SMS-texts (although this is rare). In prior art systems, a failure to have a connection with a mobile receiver (100) will cause the IP caption gateway server (200) to fail the call, and disconnect. Considering that SMS-texting is available virtually at all times, the present invention provides for delivery of captioned audio text at virtually all times.

A variation on the invention will allow for variations in the period of time between SMS-text send attempts to the mobile receiver (100), rather than having a pre-set time period. The invention can determine an appropriate interval based upon current usage of the client device (example frequency of successful SMS-text receipts) or other network characteristics, or the user may provide the interval period.

A variation on the invention will allow for the voice-to-text transcribed captions to be translated from one language to one or more other languages prior to being relayed from the SMS caption gateway server (220) to the mobile receiver (100). The translation of the transcription can be accomplished by any of a number of methods as is well known in the art, and is represented by Translator (240) in the drawings. The translation can occur after or before the transcription of the audio. The invention is intended to be independent of the particular translation method or subsystem.

The present invention reduces power consumption due to the mobile device not having a constant and persistent IP data connection to the caption gateway server (or having one active at all). The reduction in power consumption increases the battery life, the amount of time that a mobile device can operate before recharging.

The present invention reduces central processing unit (CPU) cycle consumption due to the mobile device not having a constant and persistent IP data connection to the caption gateway server (or having one active at all). The reduction in CPU cycle consumption increases the devices available capacity to process other activities, tasks and applications, increases battery life, and results in a faster, richer user experience.

The present invention reduces network consumption due to the mobile device not having a constant and persistent connection to the caption gateway server over a network. This results in dramatically decreased bandwidth utilization by the mobile device, which increases the mobile devices ability to service other applications that require network access, increases battery life, and has the potential to dramatically decrease the cost of operation to the mobile device owner (example: decreased mobile data roaming charges based on usage over conventional systems).

The present invention makes the delivery of text captions more reliable and reduces costs over conventional systems.

While certain novel features of the present invention have been shown and described, it will be understood that various omissions, substitutions and changes in the forms and details of the device illustrated and in its operation can be made by those skilled in the art without departing from the spirit of the invention. What has been described above includes examples of the present invention. It is, of course, not possible to describe every conceivable combination of components or methodologies for purposes of describing the present invention, but one of ordinary skill in the art may recognize that many further combinations and permutations of the present invention are possible. Accordingly, the present invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

I claim:

1. A method of transmitting text telecommunications data to a mobile communications device, the method comprising:
receiving an input of audio telecommunications data from a public switched telecommunications network;
converting the audio telecommunications data into text telecommunications data; and
transmission of the converted text telecommunications data via short message service to the mobile communications device.

2. The method of claim 1, further comprising:
determining a length of the text telecommunications data; and
separating the text telecommunications data into separate message units for short message service transmission.

3. The method of claim 1, where:
the conversion of the audio telecommunications data is a transcription;

4. The method of claim 1, where:
the audio telecommunications data is in a first language; and
the conversion of the audio telecommunications data is comprised of a first step of translating the audio telecommunications data from the first language into a second language; and a second step of transcribing the translated audio telecommunications data into text telecommunications data.

5. The method of claim 1, where:
the audio telecommunications data is in a first language; and
the conversion of the audio telecommunications data is comprised of a first step of transcribing the audio telecommunications data into text telecommunications data;
and a second step of translating the transcribed text telecommunications data from the first language into a second language.

6. The method of claim 1, further comprising:
determining the availability of the mobile communications device; and
delaying the transmission of the text telecommunications data to a time when the mobile communications device is available.

7. The method of claim 1, further comprising:
storing the text telecommunications data prior to delivery to the mobile communications device.

8. A method of transmitting transcribed speech data comprising:
receiving an input of audio speech data;
transcribing the audio speech data into text data; and
transmission of the transcribed text data via short message service to a mobile communications device.

9. The method of claim 8, where the audio speech data is audio from telephone call.

10. The method of claim 8, where the audio speech data is an audio track from video data.

11. The method of claim 8, where the audio speech data is an audio stream broadcast.

12. The method of claim 8, further comprising:
translating the transcribed text data into another language prior to transmission.

13. The method of claim 8, further comprising:
determining a length of the text data; and
separating the text data into separate message units for short message service transmission.

14. The method of claim 8, where:
the audio speech data is in a first language; and
the conversion of the audio speech data is comprised of a first step of translating the audio speech data from the first language into a second language; and a second step of transcribing the translated audio speech data into text data.

15. The method of claim 8, where:
the audio speech data is in a first language; and
the conversion of the audio speech data is comprised of a first step of transcribing the audio speech data into text data; and a second step of translating the text data from the first language into a second language.

16. The method of claim 8, further comprising:
determining the availability of the mobile communications device; and
delaying the transmission of the text data to a time when the mobile communications device is available.
